(19) United States
(12) Patent Application Publication
(10) Pub. No.: US 2026/0230304 A1
(43) Pub. Date: Aug. 6, 2026

(54) ELECTRONIC APPARATUS FOR MANAGING DATA ENCRYPTION KEY

(71) Applicant: Samsung Electronics Co., Ltd., Suwon-si (KR)

(72) Inventors: Jongwon KIM, Suwon-si (KR); Dongyeol KIM, Suwon-si (KR); Taehyeong LEE, Suwon-si (KR); Jinsoo KANG, Suwon-si (KR); Seungchul KO, Suwon-si (KR); Eunsoo PARK, Suwon-si (KR); Seunggyu BAEK, Suwon-si (KR); Yeonseong HWANG, Suwon-si (KR)

(21) Appl. No.: 19/636,371

(22) Filed: Apr. 1, 2026

Related U.S. Application Data
(63) Continuation of application No. PCT/KR2024/011611, filed on Aug. 6, 2024.

(30) Foreign Application Priority Data
Dec. 11, 2023 (KR) 10-2023-0178883
Dec. 26, 2023 (KR) 10-2023-0191588

(51) Int. Cl. H04L 9/08

(52) U.S. Cl. CPC H04L 9/0822; H04L 9/0838

(57) ABSTRACT

An electronic apparatus is provided. The electronic apparatus includes a communication circuit, memory, comprising one or more storage media, storing instructions, and at least one processor communicatively coupled to the communication circuit and the memory, wherein the instructions, when executed by the at least one processor individually or collectively, cause the electronic apparatus to generate a data encryption key (DEK), transmit a first DEK encryption request message including the DEK to a first DEK encryption apparatus, transmit a second DEK encryption request message including the DEK to a second DEK encryption apparatus, receive, from the first DEK encryption apparatus, a first DEK encryption response message including a first encrypted DEK (EDEK) generated by encrypting the DEK by using a first key encryption key (KEK), and identification information of the first KEK, receive, from the second DEK encryption apparatus, a second DEK encryption response message including a second EDEK generated by encrypting the DEK by using a second KEK, and identification information of the second KEK, store the first EDEK, identification information of the DEK, and the identification information of the first KEK in a first storage area of memory corresponding to the first DEK encryption apparatus, and store the second EDEK, the identification information of the DEK, and the identification information of the second KEK in a second storage area of the memory corresponding to the second DEK encryption apparatus.

### CROSS-REFERENCE TO RELATED APPLICATION(S)

This application is a continuation application, claiming priority under 35 U.S.C. § 365 (c), of an International Application No. PCT/KR2024/011611, filed on Aug. 6, 2024, which is based on and claims the benefit of a Korean patent application number 10-2023-0178883, filed on Dec. 11, 2023, in the Ministry of Intellectual Property (MOIP), and of a Korean patent application number 10-2023-0191588, filed on Dec. 26, 2023, in the Ministry of Intellectual Property (MOIP), the disclosure of each of which is incorporated by reference herein in its entirety.

### BACKGROUND

### 1. Field

The disclosure relates to an electronic apparatus for managing a key used to encrypt and decrypt data.

### 2. Description of Related Art

A data management system may encrypt data using an envelope encryption method. For example, a first electronic apparatus (e.g., key management system (KMS)) may, in response to a request of a client device, generate a data encryption key (DEK) and encrypt data using the DEK. The first electronic apparatus may return the encrypted data to the client device together with identification information of the DEK used to encrypt the corresponding data. The first electronic apparatus may request generation of a key encryption key (KEK) from a second electronic apparatus (e.g., cloud service provider (CSP)). In response to the request, the second electronic apparatus may generate the key encryption key (KEK) and return identification information of the KEK to the first electronic apparatus. The first electronic apparatus may request encryption of the DEK from the second electronic apparatus by transmitting the DEK together with the identification information of the KEK to the second electronic apparatus. In response to the request, the second electronic apparatus may encrypt (in other words, wrap) the DEK using the KEK corresponding to the identification information of the KEK received from the first electronic apparatus. The second electronic apparatus may return the encrypted DEK (EDEK) to the first electronic apparatus together with the identification information of the KEK used to encrypt the corresponding DEK. The first electronic apparatus may store the EDEK received from the second electronic apparatus in a repository in association with the identification information of the KEK used to encrypt the corresponding DEK and the identification information of the corresponding DEK.

The above information is presented as background information only to assist with an understanding of the disclosure. No determination has been made, and no assertion is made, as to whether any of the above might be applicable as prior art with regard to the disclosure.

### SUMMARY

A data management system decrypts data encrypted through an envelope encryption method. For example, a client device requests a DEK from a first electronic apparatus by transmitting identification information of the DEK to the first electronic apparatus. In response to the request, the first electronic apparatus requests decryption of an EDEK from a second electronic apparatus by obtaining the EDEK and KEK identification information related to the identification information of the DEK received from the client device from a repository and transmitting them to the second electronic apparatus. In response to the request, the second electronic apparatus decrypts the EDEK using a KEK corresponding to the KEK identification information received from the first electronic apparatus and return the DEK obtained through a decryption process to the first electronic apparatus. The client device receives the DEK through the first electronic apparatus and decrypt encrypted data using the received DEK.

In a case where the EDEK managed in the first electronic apparatus is damaged or lost, or a failure occurs in a system in the second electronic apparatus and the second electronic apparatus does not respond to the request of the first electronic apparatus, the first electronic apparatus cannot obtain an intact DEK and as a result, the encrypted data is not decrypted, so that a failure occurs in system operation (e.g., application execution) in the client device.

Aspects of the disclosure are to address at least the above-mentioned problems and/or disadvantages and to provide at least the advantages described below. Accordingly, an aspect of the disclosure is to provide an electronic apparatus allowing a normal DEK for decrypting encrypted data to be obtained.

Another aspect of the disclosure is to provide an electronic apparatus allowing a normal DEK to be obtained even if a failure occurs in a system for decrypting an EDEK or the EDEK is damaged or lost.

Another aspect of the disclosure is to provide an electronic apparatus allowing a damaged EDEK to be recovered.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a communication circuit, memory, comprising one or more storage media, storing instructions, and at least one processor communicatively coupled to the communication circuit and the memory, wherein the instructions, when executed by the at least one processor individually or collectively, cause the electronic apparatus to generate a data encryption key (DEK), transmit a first DEK encryption request message including the DEK to a first DEK encryption apparatus through the communication circuit, transmit a second DEK encryption request message including the DEK to a second DEK encryption apparatus through the communication circuit, receive a first DEK encryption response message including a first encrypted DEK (EDEK) generated by encrypting the DEK using a first key encryption key (KEK) and identification information of the first KEK from the first DEK encryption apparatus, receive a second DEK encryption response message including a second EDEK generated by encrypting the DEK using a second KEK and identification information of the second KEK from the second DEK encryption apparatus, store the first EDEK, the identification information of the DEK, and the identification information of the first KEK in a first storage area of the memory corresponding to the first DEK encryption apparatus, and store the second EDEK, the identification information of the DEK, and the identification information of the second KEK in a second storage area of the memory corresponding to the second DEK encryption apparatus.

The instructions, when executed by the processor, cause the electronic apparatus to receive a DEK inquiry request message including the identification information of the DEK from a client device through the communication circuit, and based on the DEK inquiry request message being received, transmit a first EDEK decryption request message including the first EDEK and the identification information of the first KEK to the first DEK encryption apparatus through the communication circuit. The instructions, when executed by the processor, cause the electronic apparatus to transmit a second EDEK decryption request message including the second EDEK and the identification information of the second KEK to the second DEK encryption apparatus through the communication circuit, and transmit a first DEK received from the first DEK encryption apparatus or a second DEK received from the second DEK encryption apparatus to the client device through the communication circuit.

The instructions, when executed by the processor, cause the electronic apparatus to receive a DEK inquiry request message including the identification information of the DEK from a client device through the communication circuit, and based on the DEK inquiry request message being received, transmit a first EDEK decryption request message including the first EDEK and the identification information of the first KEK to the first DEK encryption apparatus through the communication circuit. The instructions, when executed by the processor, cause the electronic apparatus to transmit a second EDEK decryption request message including the second EDEK and the identification information of the second KEK to the second DEK encryption apparatus through the communication circuit, and based on a first DEK received from the first DEK encryption apparatus and a second DEK received from the second DEK encryption apparatus being inconsistent, transmit a warning message to the client device.

The instructions, when executed by the processor, cause the electronic apparatus to, based on a predetermined EDEK examination time having arrived, transmit a first EDEK decryption request message including the first EDEK and the identification information of the first KEK to the first DEK encryption apparatus through the communication circuit, and transmit a second EDEK decryption request message including the second EDEK and the identification information of the second KEK to the second DEK encryption apparatus through the communication circuit. The instructions, when executed by the processor, cause the electronic apparatus to, based on the first DEK received from the first DEK encryption apparatus and the second DEK received from the second DEK encryption apparatus not matching, decrypt encrypted data stored in the memory with the first DEK and the second DEK, and compare sample data stored in the memory with first DEK-based decrypted data and second DEK-based decrypted data. The instructions, when executed by the processor, cause the electronic apparatus to, based on the first DEK-based decrypted data being the same as the sample data and the second DEK-based decrypted data being inconsistent with the sample data, transmit a third DEK encryption request message including the first DEK to the second DEK encryption apparatus, receive a third DEK encryption response message including a third EDEK from the second DEK encryption apparatus, and store the third EDEK in the second storage area instead of the second EDEK.

The instructions, when executed by the processor, cause the electronic apparatus to transmit a third DEK encryption request message including the DEK to a third DEK encryption apparatus through the communication circuit, and receive a third DEK encryption response message including a third EDEK generated by encrypting the DEK using a third KEK and identification information of the third KEK from the third DEK encryption apparatus. The instructions, when executed by the processor, cause the electronic apparatus to store the third EDEK, the identification information of the DEK, and the identification information of the third KEK in a third storage area of the memory corresponding to the third DEK encryption apparatus. The instructions, when executed by the processor, cause the electronic apparatus to, based on a DEK inquiry request message including the identification information of the DEK being received from a client device through the communication circuit or a predetermined EDEK examination time having arrived, transmit a first EDEK decryption request message including the first EDEK and the identification information of the first KEK to the first DEK encryption apparatus through the communication circuit, transmit a second EDEK decryption request message including the second EDEK and the identification information of the second KEK to the second DEK encryption apparatus through the communication circuit, and transmit a third EDEK decryption request message including the third EDEK and the identification information of the third KEK to the third DEK encryption apparatus through the communication circuit. The instructions, when executed by the processor, cause the electronic apparatus to, based on the first DEK received from the first DEK encryption apparatus and the second DEK received from the second DEK encryption apparatus matching each other and a third DEK received from the third DEK encryption apparatus being inconsistent with the first DEK and the second DEK, transmit a fourth DEK encryption request message including the first DEK or the second DEK to the third DEK encryption apparatus, receive a fourth DEK encryption response message including a fourth EDEK from the third DEK encryption apparatus, and store the fourth EDEK in the third storage area instead of the third EDEK.

In accordance with another aspect of the disclosure, a method performed by an electronic apparatus is provided. The method includes generating a data encryption key (DEK), transmitting a first DEK encryption request message including the DEK to a first DEK encryption apparatus, and transmitting a second DEK encryption request message including the DEK to a second DEK encryption apparatus, receiving a first DEK encryption response message including a first encrypted DEK (EDEK) generated by encrypting the DEK using a first key encryption key (KEK) and identification information of the first KEK from the first DEK encryption apparatus, receiving a second DEK encryption response message including a second EDEK generated by encrypting the DEK using a second KEK and identification information of the second KEK from the second DEK encryption apparatus, storing the first EDEK, the identification information of the DEK, and the identification information of the first KEK in a first storage area corresponding to the first DEK encryption apparatus, and storing the second EDEK, the identification information of the DEK, and the identification information of the second KEK in a second storage area corresponding to the second DEK encryption apparatus.

In accordance with another aspect of the disclosure, one or more non-transitory computer-readable storage media storing one or more computer programs including computer-executable instructions that, when executed by one or more processors of an electronic apparatus, cause the electronic apparatus to perform operations are provided. The operations include generating a data encryption key (DEK), transmitting a first DEK encryption request message including the DEK to a first DEK encryption apparatus, transmitting a second DEK encryption request message including the DEK to a second DEK encryption apparatus, receiving a first DEK encryption response message including a first encrypted DEK (EDEK) generated by encrypting the DEK using a first KEK and identification information of a first key encryption key (KEK) from the first DEK encryption apparatus, receiving a second DEK encryption response message including a second EDEK generated by encrypting the DEK using a second KEK and identification information of the second KEK from the second DEK encryption apparatus, storing the first EDEK, the identification information of the DEK, and the identification information of the first KEK in a first storage area corresponding to the first DEK encryption apparatus, and storing the second EDEK, the identification information of the DEK, and the identification information of the second KEK in a second storage area corresponding to the second DEK encryption apparatus.

According to an embodiment of the disclosure, an electronic apparatus obtains a normal DEK for decrypting encrypted data. The electronic apparatus obtains a normal DEK even if a failure occurs in a system for decrypting an EDEK or the EDEK is damaged or lost. The electronic apparatus recovers a damaged EDEK. In addition, various effects that can be directly or indirectly identified through the present document is provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic apparatus in a network environment, according to an embodiment of the disclosure;

FIG. 2 is a block diagram of a data management system according to an embodiment of the disclosure;

FIG. 3 is a block diagram of a DEK encryption apparatus according to an embodiment of the disclosure;

FIG. 4 is a flowchart for explaining operations for generating and storing an EDEK in an electronic apparatus, according to an embodiment of the disclosure;

FIG. 5 is a flowchart for explaining operations for responding to a DEK inquiry request in an electronic apparatus, according to an embodiment of the disclosure;

FIG. 6 is a flowchart for explaining operations for recovering a defective EDEK in an electronic apparatus, according to an embodiment of the disclosure; and

FIG. 7 is a flowchart for explaining operations for recovering a defective EDEK in an electronic apparatus, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

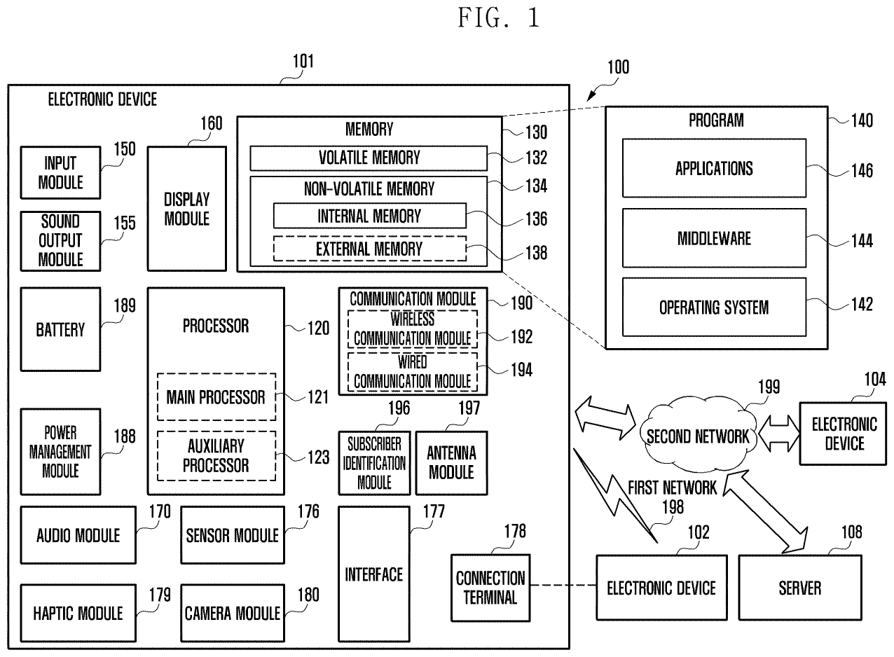

FIG. 1 is a block diagram illustrating an electronic device 101 in a network environment 100 according to an embodiment of the disclosure. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IOT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

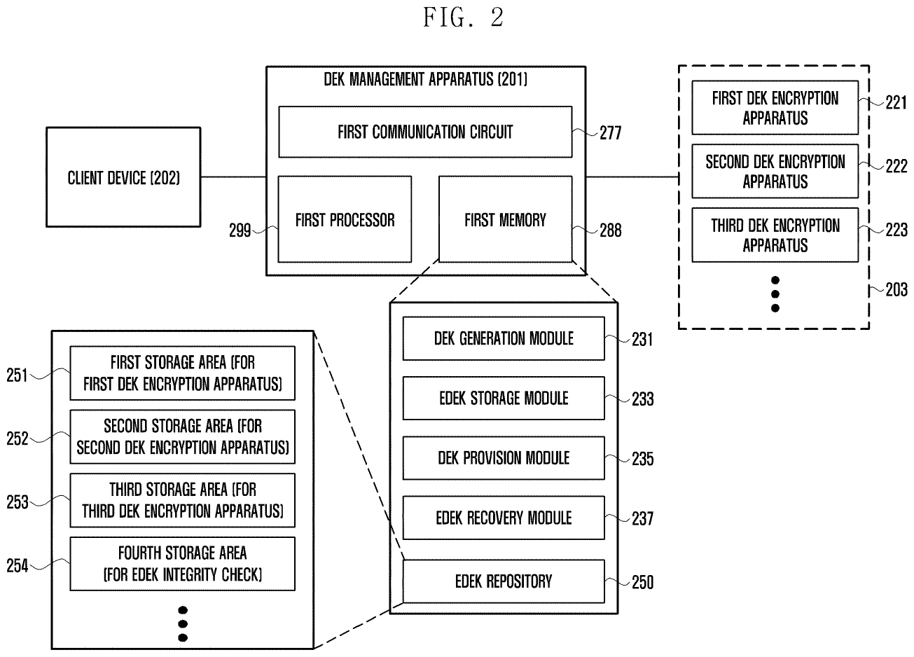

FIG. 2 is a block diagram of a data management system according to an embodiment of the disclosure. Referring to FIG. 2, a data management system may include a DEK management apparatus 201, a client device 202, and a plurality of DEK encryption apparatuses 203. The DEK management apparatus 201 (e.g., the server 108 of FIG. 1) may include a first communication circuit 277, first memory 288, and a first processor 299. The components of the DEK management apparatus 201 may be operatively, functionally, and/or electrically connected to each other. The first communication circuit 277, the first memory 288, and the first processor 299 may perform the same functions by being implemented substantially the same as the communication module 190, the memory 130, and the processor 120 of FIG. 1, respectively. The first memory 288 may store a program for DEK management (e.g., DEK generation, responding to a DEK request of a client, and recovering a forged/altered EDEK). The first memory 288 may include volatile memory and non-volatile memory. A program (e.g., the program 140 of FIG. 1) may be stored as instructions in the non-volatile memory, loaded into the volatile memory, and executed by the first processor 299. The program, when executed by the first processor 299, may cause the DEK management apparatus 201 to perform given operations for DEK management. According to an embodiment, the program may include a DEK generation module 231, an EDEK storage module 233, a DEK provision module 235, and an EDEK recovery module 237.

The DEK generation module 231 may generate a data encryption key (DEK) used to encrypt data and decrypt encrypted data. In addition, the DEK generation module 231 may generate an identification (ID) as identification information for identification of the generated DEK. As an example, the DEK generation module 231 may receive a data encryption request message including data from the client device 202 (e.g., the electronic apparatus 101 or the electronic apparatus 104 of FIG. 1) through the first communication circuit 277. In response to the data encryption request, the DEK generation module 231 may generate the DEK and its ID. The DEK generation module 231 may reply to the client device 202 with a data encryption response message including the encrypted data and the DEK ID through the first communication circuit 277.

The EDEK storage module 233 may transmit a DEK encryption request message including the generated DEK to the DEK encryption apparatuses 203 through the first communication circuit 277. The DEK generation module may receive a DEK encryption response message including an encrypted DEK (hereinafter, EDEK) and an ID of a KEK used to encrypt the DEK from the DEK encryption apparatuses 203 through the first communication circuit 277. The EDEK storage module 233 may store the EDEK and the KEK ID in the first memory 288.

The first memory 288 may include an EDEK repository 250 for storing EDEKs received from the DEK encryption apparatuses 203. The EDEK storage module 233 may store the KEK ID and the EDEK respectively received from the DEK encryption apparatuses 203 in the EDEK repository 250 together with the corresponding DEK ID. According to an embodiment, the EDEK repository 250 may include storage areas respectively corresponding to the DEK encryption apparatuses 203. For example, with reference to Table 1 below, the EDEK repository 250 may include a first storage area 251 for storing a KEK ID and an EDEK received from a first DEK encryption apparatus 221, a second storage area 252 for storing a KEK ID and an EDEK received from a second DEK encryption apparatus 222, and a third storage area 253 for storing a KEK ID and an EDEK received from a third DEK encryption apparatus 223.

TABLE 1

| First storage area 251 | | | Second storage area 252 | | | Third storage area 253 | | |
|---|---|---|---|---|---|---|---|---|
| DEK | KEK | | DEK | KEK | | DEK | KEK | |
| ID | ID | EDEK | ID | ID | EDEK | ID | ID | EDEK |
| 12 | A1 | KEK_{—} | 12 | B1 | KEK_{—} | 12 | C1 | KEK_{—} |
| | | A1(DEK_12) | | | B1(DEK_12) | | | C1(DEK_12) |
| 34 | A2 | KEK_{—} | 34 | B2 | KEK_{—} | 34 | C2 | KEK_{—} |
| | | A2(DEK_34) | | | B2(DEK_34) | | | C2(DEK_34) |

The client device 202 may request a DEK from the DEK management apparatus 201 to decrypt encrypted data in relation to a service (e.g., application execution). The DEK provision module 235 may receive a DEK inquiry request message including a DEK ID from the client device 202 through the first communication circuit 277. In response to the DEK inquiry request, the DEK provision module 235 may obtain a corresponding EDEK from the EDEK repository 250 and transmit an EDEK decryption request message including the obtained EDEK to the DEK encryption apparatuses 203. The DEK provision module 235 may receive EDEK decryption response messages including the DEK from the DEK encryption apparatuses 203. The DEK provision module 235 may transmit a DEK inquiry response message including the DEK to the client device 202 through the first communication circuit 277.

As an example, with reference to Table 1, in a case where the ID of the DEK required by the client device 202 is “12,” the DEK provision module 235 may obtain a KEK ID “A1” and an EDEK “KEK_A1 (DEK_12)” corresponding to the DEK ID “12” from the first storage area 251 and transmit a first EDEK decryption request message including the obtained KEK ID and EDEK to the first DEK encryption apparatus 221. The DEK provision module 235 may obtain a KEK ID “B1” and an EDEK “KEK_B1 (DEK_12)” corresponding to the DEK ID “12” from the second storage area 252 and transmit a second EDEK decryption request message including the obtained KEK ID and EDEK to the second DEK encryption apparatus 222. The DEK provision module 235 may obtain a KEK ID “C1” and an EDEK “KEK_C1 (DEK_12)” corresponding to the DEK ID “12” from the third storage area 253 and transmit a third EDEK decryption request message including the obtained KEK ID and EDEK to the third DEK encryption apparatus 223. EDEK decryption response messages including DEK_12 may be received from the DEK encryption apparatuses 221, 222, and 223. A DEK inquiry response message including DEK_12 may be transmitted to the client device 202 through the first communication circuit 277.

According to an embodiment, the DEK provision module 235 may obtain the DEK from the EDEK decryption response message that arrived the earliest and reply to the client device 202. This embodiment may be implemented in a data management system where a fast response to a request of the client device 202 is required.

According to an embodiment, in a case where EDEK decryption response messages are returned from all of the DEK encryption apparatuses 203 and the DEKs obtained from the EDEK decryption response messages are all the same, the DEK provision module 235 may transmit the DEK inquiry response message including the DEK to the client device 202 through the first communication circuit 277. This embodiment may be implemented in a data management system where high reliability of a response to a request of the client device 202 is required. In a case where the obtained DEKs do not match, the DEK provision module 235 may transmit a warning message indicating that the DEK cannot be trusted to the client device 202 through the first communication circuit 277.

The EDEK recovery module 237 may recover an EDEK confirmed to have a defect (e.g., forgery or alteration) among EDEKs stored in the EDEK repository 250.

According to an embodiment, there may be three or more DEK encryption apparatuses 203 as illustrated in FIG. 2. In response to the DEK inquiry request of the client device 202, the DEK provision module 235 may obtain DEKs from three or more DEK encryption apparatuses 203. One among the obtained three or more DEKs may not match the other DEKs. The EDEK recovery module 237 may determine the other DEKs matching each other to be normal. The EDEK recovery module 237 may determine that the corresponding EDEK of one DEK that does not match the other DEKs has a defect. The EDEK recovery module 237 may recover the defective EDEK using a DEK found to be normal among those obtained from the DEK encryption apparatuses 203. The EDEK recovery module 237 may store the recovered EDEK in the EDEK repository 250 instead of the defective EDEK.

When an example of the above embodiment is described with reference to Table 1, the ID of the DEK for which the client device 202 requested inquiry is ‘34’, and accordingly, the DEKs obtained from the first DEK encryption apparatus 221 and the second DEK encryption apparatus 222 are the same as “DEK_34,” whereas the DEK obtained from the third DEK encryption apparatus 223 may not be “DEK_34.” In such a case, the EDEK recovery module 237 may determine that “KEK_C2(DEK_34)” stored in the third storage area 253 has a defect. The EDEK recovery module 237 may transmit a DEK encryption request message including the obtained “DEK_34” to the third DEK encryption apparatus 223. In response to the DEK encryption request, the EDEK recovery module 237 may receive a DEK encryption response message including an EDEK and an ID of a KEK used to encrypt DEK_34 from the third DEK encryption apparatus 223. For example, as in Table 2 below, the EDEK recovery module 237 may receive a KEK ID “C3” and “KEK_C3(DEK_34)” encrypted using ‘C3’ from the third DEK encryption apparatus 223 and store them in the third storage area 253 to correspond to the DEK ID “34.”

TABLE 2

| First storage area 251 | | | Second storage area 252 | | | Third storage area 253 | | |
|---|---|---|---|---|---|---|---|---|
| DEK | KEK | | DEK | KEK | | DEK | KEK | |
| ID | ID | EDEK | ID | ID | EDEK | ID | ID | EDEK |
| 12 | A1 | KEK_{—} | 12 | B1 | KEK_{—} | 12 | C1 | KEK_{—} |
| | | A1(DEK_12) | | | B1(DEK_12) | | | C1(DEK_12) |
| 34 | A2 | KEK_{—} | 34 | B2 | KEK_{—} | 34 | C3 | KEK_{—} |
| | | A2(DEK_34) | | | B2(DEK_34) | | | C3(DEK_34) |

According to an embodiment, there may be three or more DEK encryption apparatuses 203 as illustrated in FIG. 2. The EDEK recovery module 237 may examine (or check), at every predetermined cycle, whether there is a defect (e.g., forgery or alteration) in EDEKs stored in the EDEK repository 250. The EDEK recovery module 237 may recover a defective EDEK and store a recovered EDEK in the EDEK repository 250 instead of the defective EDEK.

When an example of the above embodiment is described with reference to Table 1, an examination time (or checking time) of an EDEK corresponding to a DEK ID “34” arrives according to a predetermined cycle, and accordingly, the EDEK recovery module 237 may obtain a KEK ID “A2” and an EDEK “KEK_A2 (DEK_34)” from a first storage area 251 and transmit a first EDEK decryption request message including the obtained KEK ID and EDEK to a first DEK encryption apparatus 221. The EDEK recovery module 237 may obtain a KEK ID “B2” and an EDEK “KEK_B2(DEK_34)” from a second storage area 252 and transmit a second EDEK decryption request message including the obtained KEK ID and EDEK to a second DEK encryption apparatus 222. The EDEK recovery module 237 may obtain a KEK ID “C2” and an EDEK “KEK_C2(DEK_34)” from a third storage area 253 and transmit a third EDEK decryption request message including the obtained KEK ID and EDEK to a third DEK encryption apparatus 223. As a response to the EDEK decryption request, the EDEK recovery module 237 may receive DEKs from the DEK encryption apparatuses 203. The DEKs obtained from the first DEK encryption apparatus 221 and the second DEK encryption apparatus 222 are the same as “DEK_34,” whereas the DEK obtained from the third DEK encryption apparatus 223 may not be “DEK_34.” In such a case, the EDEK recovery module 237 may determine that “KEK_C2(DEK_34)” stored in the third storage area 253 has a defect. The EDEK recovery module 237 may transmit a DEK encryption request message including the obtained “DEK_34” to the third DEK encryption apparatus 223. In response to the DEK encryption request, the EDEK recovery module 237 may receive a DEK encryption response message including an EDEK and an ID of a KEK used to encrypt DEK_34 from the third DEK encryption apparatus 223. For example, as in Table 2 above, the EDEK recovery module 237 may receive a KEK ID “C3” and “KEK_C3(DEK_34)” encrypted using ‘C3’ from the third DEK encryption apparatus 223 and store them in the third storage area 253 to correspond to the DEK ID “34.”

According to an embodiment, the DEK encryption apparatuses 203 may be two or more. Sample data (in other words, first data) used to examine whether an EDEK has a defect and encrypted data (in other words, second data) generated by encrypting the sample data using a DEK may be stored in the EDEK repository 250. For example, as in Table 3 below, the DEK generation module 231 may, upon DEK generation, generate encrypted data by encrypting sample data using the generated DEK. The DEK generation module 231 may store the encrypted data in a fourth storage area 254 of the EDEK repository 250 in association with the corresponding DEK ID and sample data. The EDEK recovery module 237 may obtain a DEK from a plurality of DEK encryption apparatuses according to a DEK inquiry request of the client device 202 or a predetermined cycle. The EDEK recovery module 237 may confirm that the plurality of obtained DEKs are not the same as each other. Accordingly, the EDEK recovery module 237 may decrypt the encrypted data stored in the fourth storage area 254 with the plurality of DEKs. The EDEK recovery module 237 may compare each decrypted data with the sample data. The EDEK recovery module 237 may determine a DEK corresponding to decrypted data that is the same as the sample data to be normal, and may determine an EDEK corresponding to decrypted data that does not match the sample data to be defective. The EDEK recovery module 237 may recover the defective EDEK using a DEK found to be normal among those obtained from the DEK encryption apparatuses 203. The EDEK recovery module 237 may store the recovered EDEK in the EDEK repository 250 instead of the defective EDEK.

TABLE 3
Fourth storage area 254

| DEK ID | Sample data | Encrypted data |
|---|---|---|
| 12 | abcd | DEK-12(abcd) |
| 34 | efgh | DEK-34(efgh) |

When an example of the above embodiment is described with reference to Tables 2 and 3, an examination target among EDEKs stored in the EDEK repository 250 may be an EDEK corresponding to a DEK ID “34.” The EDEK recovery module 237 may obtain a DEK corresponding to the DEK ID “34” (hereinafter, a first DEK) from a first DEK encryption apparatus 221. The EDEK recovery module 237 may obtain a DEK corresponding to the DEK ID “34” (hereinafter, a third DEK) from a third DEK encryption apparatus 223. The EDEK recovery module 237 may, based on confirming that the first DEK and the third DEK are not the same, decrypt “DEK-34(efgh)” with the first DEK and the third DEK. The EDEK recovery module 237 may compare each decrypted data with “efgh.” As a result of comparison, the EDEK recovery module 237 may confirm that first DEK-based decrypted data is the same as “efgh” and third DEK-based decrypted data is inconsistent with “efgh.” Accordingly, the EDEK recovery module 237 may determine the first DEK to be normal and may determine that “KEK_C2(DEK_34)” corresponding to the third DEK has a defect. The EDEK recovery module 237 may transmit a DEK encryption request message including the first DEK determined to be normal to the third DEK encryption apparatus 223. In response to the DEK encryption request, the EDEK recovery module 237 may receive a DEK encryption response message including an EDEK and an ID of a KEK used to encrypt DEK_34 from the third DEK encryption apparatus 223. For example, as in Table 2 above, the EDEK recovery module 237 may receive a KEK ID “C3” and “KEK_C3(DEK_34)” encrypted using ‘C3’ from the third DEK encryption apparatus 223 and store them in the third storage area 253 to correspond to the DEK ID “34.”

In Table 3, it is exemplified that sample data is different for each DEK, but it is not limited thereto. For example, the EDEK recovery module 237 may use one sample data for an EDEK integrity check.

According to an embodiment, at least one storage area in the EDEK repository 250 may be provided in an external device (e.g., a cloud server). Accordingly, the DEK management apparatus 201 may access the EDEK repository of the external device through the first communication circuit 277 to read and write data.

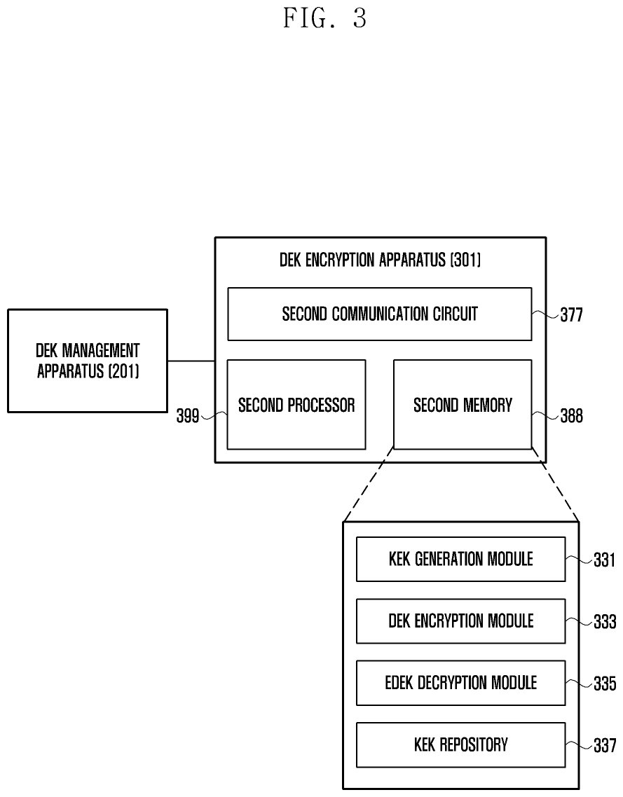

FIG. 3 is a block diagram of a DEK encryption apparatus 301 according to an embodiment of the disclosure. Referring to FIG. 3, the DEK encryption apparatus 301 may include a second communication circuit 377, second memory 388, and a second processor 399. The components of the DEK encryption apparatus 301 may be operatively, functionally, and/or electrically connected to each other. The second communication circuit 377, the second memory 388, and the second processor 399 may perform the same functions by being implemented substantially the same as the communication module 190, the memory 130, and the processor 120 of FIG. 1, respectively. The second memory 388 may store a program for a response (e.g., KEK generation, DEK encryption, and EDEK decryption) to a request of the DEK management apparatus 201. The second memory 388 may include volatile memory and non-volatile memory. A program (e.g., the program 140 of FIG. 1) may be stored as instructions in the non-volatile memory, loaded into the volatile memory, and executed by the second processor 399. The program, when executed by the second processor 399, may cause the DEK encryption apparatus 301 to perform given operations for a response to a request of the DEK management apparatus 201. According to an embodiment, the program may include a KEK generation module 331, a DEK encryption module 333, and an EDEK decryption module 335.

The KEK generation module 331 may generate a key encryption key (KEK) used to encrypt a data encryption key (DEK) and decrypt the encrypted DEK. The KEK generation module 331 may generate an identification (ID) as identification information for identification of the generated KEK. The KEK generation module 331 may store the KEK and a corresponding ID in a KEK repository 337 (e.g., see Table 4 below) of the second memory 388.

TABLE 4

| KEK ID | KEK |
|---|---|
| A1 | KEK_A1 |
| A2 | KEK_A2 |

The DEK encryption module 333 may receive a DEK encryption request message from the DEK management apparatus 201 (e.g., the EDEK storage module 233 or the EDEK recovery module 237). The DEK encryption module 333 may obtain a DEK from the DEK encryption request message, encrypt the obtained DEK using one among KEKs stored in the KEK repository 337, include an EDEK together with an ID of the corresponding KEK in a DEK encryption response message, and transmit the DEK encryption response message to the DEK management apparatus 201.

The EDEK decryption module 335 may receive an EDEK decryption request message from the DEK management apparatus 201 (e.g., the DEK provision module 235 or the EDEK recovery module 237). The EDEK decryption module 335 may obtain an EDEK and a KEK ID from the EDEK decryption request message, obtain a KEK of the obtained ID from the KEK repository 337, obtain a DEK by decrypting the EDEK using the obtained KEK, and transmit an EDEK decryption response message including the obtained DEK to the DEK management apparatus 201.

According to an embodiment, at least one among the DEK encryption apparatuses 203 of FIG. 2 may have the configurations of the DEK encryption apparatus 301.

According to an embodiment, the DEK encryption apparatus 301 may be configured in the DEK management apparatus 201 (e.g., the server 108 of FIG. 1). For example, the KEK generation module 331, the DEK encryption module 333, the EDEK decryption module 335, and the KEK repository 337 may be stored in the first memory 288 and executed by the first processor 299.

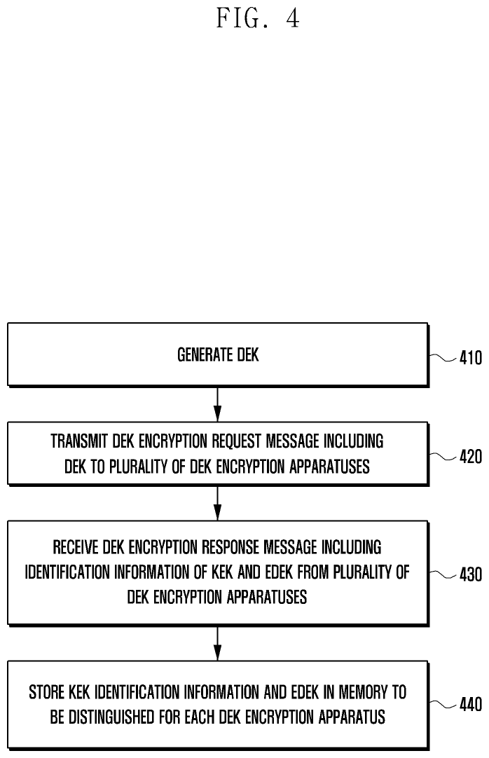

FIG. 4 is a flowchart for explaining operations for generating and storing an EDEK in an electronic apparatus, according to an embodiment of the disclosure. When instructions (e.g., the modules 231 and 233 of FIG. 2) stored in memory of an electronic apparatus (e.g., the DEK management apparatus 201) are executed by a processor of the electronic apparatus, operations of FIG. 4 may be performed by the electronic apparatus.

In operation 410, the electronic apparatus may generate a DEK used to encrypt data. As an example, the electronic apparatus may generate a DEK in response to a data encryption request of an external device (e.g., the client device 202).

In operation 420, the electronic apparatus may transmit a DEK encryption request message including the DEK generated in operation 410 to a plurality of DEK encryption apparatuses.

In operation 430, the electronic apparatus may receive a DEK encryption response message including an EDEK generated by encrypting the DEK generated in operation 410 using a KEK and identification information of the KEK used to encrypt the DEK from the plurality of DEK encryption apparatuses.

As an example of operation 420 and 430, the electronic apparatus may transmit a first DEK encryption request message including the DEK generated in operation 410 to a first DEK encryption apparatus 221, and transmit a second DEK encryption request message including the DEK generated in operation 410 to a second DEK encryption apparatus 222. The electronic apparatus may receive a first DEK encryption response message including a first EDEK generated by encrypting the DEK generated in operation 410 using a first KEK and identification information of the first KEK from the first DEK encryption apparatus 221. The electronic apparatus may receive a second DEK encryption response message including a second EDEK generated by encrypting the DEK generated in operation 410 using a second KEK and identification information of the second KEK from the second DEK encryption apparatus 222. The electronic apparatus may additionally transmit the DEK generated in operation 410 to another DEK encryption apparatus. For example, the electronic apparatus may transmit a third DEK encryption request message including the DEK generated in operation 410 to a third DEK encryption apparatus 223. The electronic apparatus may receive a third DEK encryption response message including a third EDEK generated by encrypting the DEK generated in operation 410 using a third KEK and identification information of the third KEK from the third DEK encryption apparatus 223.

In operation 440, the electronic apparatus may obtain identification information of a KEK and an EDEK from each of a plurality of DEK encryption response messages, and store the obtained KEK identification information and EDEK in memory such that they are distinguished for each DEK encryption apparatus.

As an example of operation 440, the electronic apparatus may store identification information of the DEK generated in operation 410 and identification information of the first KEK and the first EDEK received from the first DEK encryption apparatus 221 in a first storage area (e.g., the first storage area 251 of FIG. 2) corresponding to the first DEK encryption apparatus 221. The electronic apparatus may store the identification information of the DEK generated in operation 410 and identification information of the second KEK and the second EDEK received from the second DEK encryption apparatus 222 in a second storage area (e.g., the second storage area 252 of FIG. 2) corresponding to the second DEK encryption apparatus 222. The electronic apparatus may additionally receive a DEK encryption response message from another DEK encryption apparatus. For example, the electronic apparatus may store the identification information of the DEK generated in operation 410 and identification information of the third KEK and the third EDEK received from the third DEK encryption apparatus 223 in a third storage area (e.g., the third storage area 253 of FIG. 2) corresponding to the third DEK encryption apparatus 223.

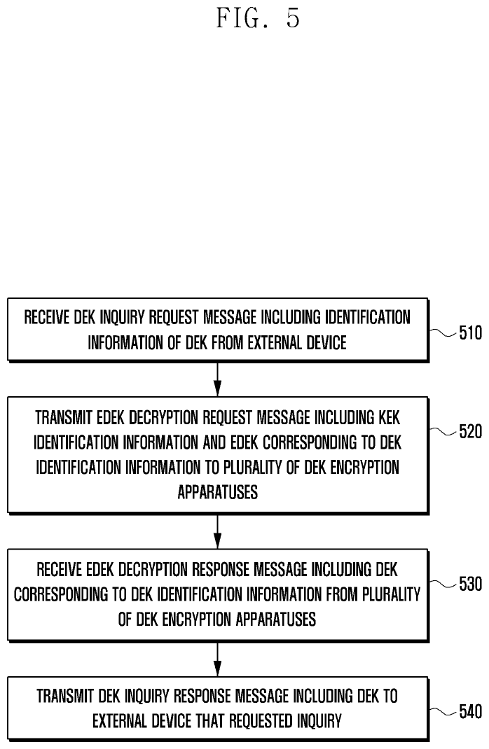

FIG. 5 is a flowchart for explaining operations for responding to a DEK inquiry request in an electronic apparatus, according to an embodiment of the disclosure. When instructions (e.g., the DEK provision module 235 of FIG. 2) stored in memory of an electronic apparatus (e.g., the DEK management apparatus 201) are executed by a processor of the electronic apparatus, operations of FIG. 5 may be performed by the electronic apparatus.

In operation 510, the electronic apparatus may receive a DEK inquiry request message including identification information of a DEK from an external device (e.g., the client device 202 of FIG. 2).

In operation 520, the electronic apparatus may, in response to the DEK inquiry request, transmit an EDEK decryption request message including KEK identification information and an EDEK corresponding to the DEK identification information received in operation 510 to a plurality of DEK encryption apparatuses.

In operation 530, the electronic apparatus may receive an EDEK decryption response message including a DEK corresponding to the DEK identification information received in operation 510 from the plurality of DEK encryption apparatuses.

As an example of operation 520 and 530, the electronic apparatus may obtain identification information of a first KEK and a first EDEK corresponding to the DEK identification information received in operation 510 from a first storage area (e.g., the first storage area 251 of FIG. 2), and transmit a first EDEK decryption request message including the obtained identification information of the first KEK and the first EDEK to a first DEK encryption apparatus 221. The electronic apparatus may obtain identification information of a second KEK and a second EDEK corresponding to the DEK identification information received in operation 510 from a second storage area (e.g., the second storage area 252 of FIG. 2), and transmit a second EDEK decryption request message including the obtained identification information of the second KEK and the second EDEK to a second DEK encryption apparatus 222. The electronic apparatus may receive a first EDEK decryption response message including a first DEK corresponding to the DEK identification information received in operation 510 from the first EDK encryption apparatus 221. The electronic apparatus may receive a second EDEK decryption response message including a second DEK corresponding to the DEK identification information received in operation 510 from the second EDK encryption apparatus 222. The electronic apparatus may additionally transmit an EDEK decryption request message to another DEK encryption apparatus. For example, the electronic apparatus may obtain identification information of a third KEK and a third EDEK corresponding to the DEK identification information received in operation 510 from a third storage area (e.g., the third storage area 253 of FIG. 2), and transmit a third EDEK decryption request message including the obtained identification information of the third KEK and the third EDEK to a third DEK encryption apparatus 223. The electronic apparatus may receive a third EDEK decryption response message including a third DEK corresponding to the DEK identification information received in operation 510 from the third EDK encryption apparatus 223.

In operation 540, the electronic apparatus may transmit a DEK inquiry response message including the DEK received from the DEK encryption apparatus to the external device that requested the inquiry. As an example, the electronic apparatus may obtain the DEK from the EDEK decryption response message that arrived the earliest and reply to the external device that requested the inquiry. As another example, in a case where EDEK decryption response messages are returned from all of a plurality of encryption apparatuses and all DEKs obtained from the EDEK decryption response messages are the same, the electronic apparatus may reply with the DEK to the external device that requested the inquiry. In a case where even one among the obtained DEKs is not the same, the electronic apparatus may transmit a warning message to the external device that requested the inquiry.

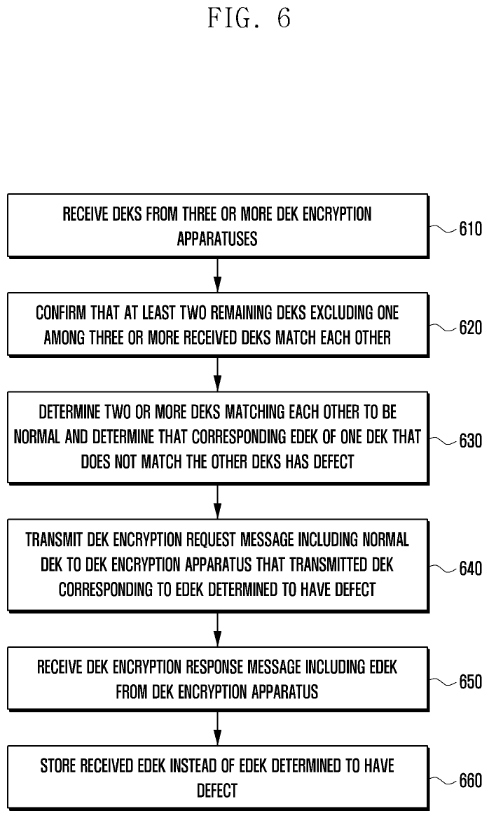

FIG. 6 is a flowchart for explaining operations for recovering a defective EDEK in an electronic apparatus, according to an embodiment of the disclosure. When instructions (e.g., the EDEK recovery modules 237 of FIG. 2) stored in memory of an electronic apparatus (e.g., the DEK management apparatus 201) are executed by a processor of the electronic apparatus, operations of FIG. 6 may be performed by the electronic apparatus.

In operation 610 (e.g., operation 530), the electronic apparatus may receive DEKs from three or more DEK encryption apparatuses.

In operation 620, the electronic apparatus may confirm that at least two remaining DEKs excluding one among the three or more received DEKs match each other.

In operation 630, the electronic apparatus may determine the two or more DEKs matching each other to be normal DEKs and may determine that the corresponding EDEK of the one DEK that does not match the other DEKs has a defect.

In operation 640, the electronic apparatus may transmit a DEK encryption request message including a normal DEK to the DEK encryption apparatus that transmitted the DEK corresponding to the EDEK determined to have a defect.

In operation 650, the electronic apparatus may receive a DEK encryption response message including an EDEK from the DEK encryption apparatus.

In operation 660, the electronic apparatus may store the received EDEK in the memory instead of the EDEK determined to have a defect.

As an example of the above-described operations of FIG. 6, the electronic apparatus may receive a first EDEK decryption response message including a first DEK corresponding to the DEK identification information received in operation 510 from a first EDK encryption apparatus (e.g., the first EDK encryption apparatus 221 of FIG. 2). The electronic apparatus may receive a second EDEK decryption response message including a second DEK corresponding to the DEK identification information received in operation 510 from a second EDK encryption apparatus (e.g., the second EDK encryption apparatus 222). The electronic apparatus may receive a third EDEK decryption response message including a third DEK corresponding to the DEK identification information received in operation 510 from a third EDK encryption apparatus (e.g., the third EDK encryption apparatus 223). The electronic apparatus may confirm that the second DEK and the third DEK match each other and the first DEK does not match the other DEKs. According to a result of the confirmation, the electronic apparatus may determine the second DEK and the third DEK to be normal and may determine a first EDEK corresponding to the first DEK to be a defective EDEK. The electronic apparatus may transmit a DEK encryption request message including the second DEK or the third DEK to the first EDK encryption apparatus. The electronic apparatus may receive a DEK encryption response message including a fourth EDEK from the first EDK encryption apparatus. The electronic apparatus may store the fourth EDEK in a storage area (e.g., the first storage area 251 of FIG. 2) corresponding to the first EDK encryption apparatus 221, instead of the first EDEK.

As another example of the above-described operations of FIG. 6, as it becomes a designated time for examining whether there is a defect (e.g., forgery or alteration) in EDEKs stored in the EDEK repository 250, the electronic apparatus may obtain an ID of a first KEK and a first EDEK corresponding thereto from a first storage area (e.g., the first storage area 251 of FIG. 2) and transmit them to a first DEK encryption apparatus (e.g., the first DEK encryption apparatus 221) by including them in a first EDEK decryption request message. The electronic apparatus may obtain an ID of a second KEK and a second EDEK corresponding thereto from a second storage area (e.g., the second storage area 252 of FIG. 2) and transmit them to a second DEK encryption apparatus (e.g., the second DEK encryption apparatus 222) by including them in a second EDEK decryption request message. The electronic apparatus may obtain an ID of a third KEK and a third EDEK corresponding thereto from a third storage area (e.g., the third storage area 253 of FIG. 2) and transmit them to a third DEK encryption apparatus (e.g., the second DEK encryption apparatus 222) by including them in a third EDEK decryption request message. The electronic apparatus may receive a first EDEK decryption response message including a first DEK from the first EDK encryption apparatus. The electronic apparatus may receive a second EDEK decryption response message including a second DEK from the second EDK encryption apparatus. The electronic apparatus may receive a third EDEK decryption response message including a third DEK from the third EDK encryption apparatus. The electronic apparatus may confirm that the second DEK and the third DEK match each other and the first DEK does not match the other DEKs. According to a result of the confirmation, the electronic apparatus may determine the second DEK and the third DEK to be normal and may determine a first EDEK corresponding to the first DEK to be a defective EDEK. The electronic apparatus may transmit a DEK encryption request message including the second DEK or the third DEK to the first EDK encryption apparatus. The electronic apparatus may receive a DEK encryption response message including a fourth EDEK from the first EDK encryption apparatus. The electronic apparatus may store the fourth EDEK in the first storage area, instead of the first EDEK.

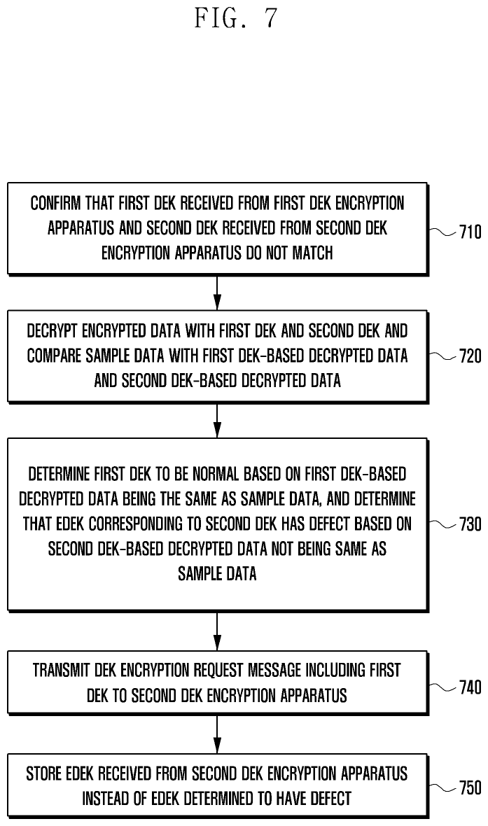

FIG. 7 is a flowchart for explaining operations for recovering a defective EDEK in an electronic apparatus, according to an embodiment of the disclosure. When instructions (e.g., the EDEK recovery modules 237 of FIG. 2) stored in memory of an electronic apparatus (e.g., the DEK management apparatus 201) are executed by a processor of the electronic apparatus, operations of FIG. 7 may be performed by the electronic apparatus.

In operation 710, the electronic apparatus may confirm that a first DEK received from a first DEK encryption apparatus (e.g., the first DEK encryption apparatus 221 of FIG. 2) and a second DEK received from a second DEK encryption apparatus (e.g., the second DEK encryption apparatus 222 of FIG. 2) do not match. The first DEK and the second DEK may be those received based on a DEK inquiry request of an external device (e.g., the client device 202 of FIG. 2) or a predetermined EDEK examination cycle.

In operation 720, the electronic apparatus may obtain encrypted data and sample data from memory (e.g., the fourth storage area 254 of FIG. 2) and decrypt the obtained encrypted data with the first DEK and the second DEK. The electronic apparatus may compare the sample data corresponding to the obtained encrypted data with first DEK-based decrypted data and second DEK-based decrypted data.

In operation 730, the electronic apparatus may determine the first DEK to be normal based on the first DEK-based decrypted data being the same as the sample data. The electronic apparatus may determine that an EDEK corresponding to the second DEK is defective based on second DEK-based decrypted data being inconsistent with the sample data.

In operation 740, the electronic apparatus may transmit a DEK encryption request message including the first DEK to the second DEK encryption apparatus.

In operation 750, the electronic apparatus may receive a DEK encryption response message including an EDEK from the second DEK encryption apparatus. The electronic apparatus may store the received EDEK in the memory instead of the EDEK determined to have a defect.

According to an embodiment, an electronic apparatus (e.g., the DEK management apparatus 201 of FIG. 2) includes a communication circuit; at least one processor; and memory storing instructions. The instructions, when executed by the processor, may cause the electronic apparatus to generate a data encryption key (DEK), transmit a first DEK encryption request message including the DEK to a first DEK encryption apparatus through the communication circuit, and transmit a second DEK encryption request message including the DEK to a second DEK encryption apparatus through the communication circuit. The instructions, when executed by the processor, may cause the electronic apparatus to receive a first DEK encryption response message including a first encrypted DEK (EDEK) generated by encrypting the DEK using a first KEK and identification information of the first KEK from the first DEK encryption apparatus, and receive a second DEK encryption response message including a second EDEK generated by encrypting the DEK using a second KEK and identification information of the second KEK from the second DEK encryption apparatus. The instructions, when executed by the processor, may cause the electronic apparatus to store the first EDEK, the identification information of the DEK, and the identification information of the first KEK in a first storage area of the memory corresponding to the first DEK encryption apparatus, and store the second EDEK, the identification information of the DEK, and the identification information of the second KEK in a second storage area of the memory corresponding to the second DEK encryption apparatus.

The instructions, when executed by the processor, may cause the electronic apparatus to receive a DEK inquiry request message including the identification information of the DEK from a client device through the communication circuit. The instructions, when executed by the processor, may cause the electronic apparatus to, based on the DEK inquiry request message being received, transmit a first EDEK decryption request message including the first EDEK and the identification information of the first KEK to the first DEK encryption apparatus through the communication circuit, and transmit a second EDEK decryption request message including the second EDEK and the identification information of the second KEK to the second DEK encryption apparatus through the communication circuit. The instructions, when executed by the processor, may cause the electronic apparatus to transmit a first DEK received from the first DEK encryption apparatus or a second DEK received from the second DEK encryption apparatus to the client device through the communication circuit.

The instructions, when executed by the processor, may cause the electronic apparatus to transmit one that arrived first among the first DEK and the second DEK to the client device through the communication circuit.

The instructions, when executed by the processor, may cause the electronic apparatus to, based on the first DEK and the second DEK matching each other, transmit the first DEK or the second DEK to the client device.

The instructions, when executed by the processor, may cause the electronic apparatus to receive a DEK inquiry request message including the identification information of the DEK from a client device through the communication circuit, and based on the DEK inquiry request message being received, transmit a first EDEK decryption request message including the first EDEK and the identification information of the first KEK to the first DEK encryption apparatus through the communication circuit, and transmit a second EDEK decryption request message including the second EDEK and the identification information of the second KEK to the second DEK encryption apparatus through the communication circuit. The instructions, when executed by the processor, may cause the electronic apparatus to, based on the first DEK received from the first DEK encryption apparatus and the second DEK received from the second DEK encryption apparatus being inconsistent, transmit a warning message to the client device.

The instructions, when executed by the processor, may cause the electronic apparatus to, based on a predetermined EDEK examination time having arrived, transmit a first EDEK decryption request message including the first EDEK and the identification information of the first KEK to the first DEK encryption apparatus through the communication circuit, and transmit a second EDEK decryption request message including the second EDEK and the identification information of the second KEK to the second DEK encryption apparatus through the communication circuit. The instructions, when executed by the processor, may cause the electronic apparatus to, based on the first DEK received from the first DEK encryption apparatus and the second DEK received from the second DEK encryption apparatus not matching, decrypt encrypted data stored in the memory with the first DEK and the second DEK, and compare sample data stored in the memory with first DEK-based decrypted data and second DEK-based decrypted data. The instructions, when executed by the processor, may cause the electronic apparatus to, based on the first DEK-based decrypted data being the same as the sample data and the second DEK-based decrypted data being inconsistent with the sample data, transmit a third DEK encryption request message including the first DEK to the second DEK encryption apparatus. The instructions, when executed by the processor, may cause the electronic apparatus to receive a third DEK encryption response message including a third EDEK from the second DEK encryption apparatus, and store the third EDEK in the second storage area instead of the second EDEK.

The instructions, when executed by the processor, may cause the electronic apparatus to transmit a third DEK encryption request message including the DEK to a third DEK encryption apparatus through the communication circuit, and receive a third DEK encryption response message including a third EDEK generated by encrypting the DEK using a third KEK and identification information of the third KEK from the third DEK encryption apparatus. The instructions, when executed by the processor, may cause the electronic apparatus to store the third EDEK, the identification information of the DEK, and the identification information of the third KEK in a third storage area of the memory corresponding to the third DEK encryption apparatus. The instructions, when executed by the processor, may cause the electronic apparatus to, based on a DEK inquiry request message including the identification information of the DEK being received from a client device through the communication circuit or a predetermined EDEK examination time having arrived, transmit a first EDEK decryption request message including the first EDEK and the identification information of the first KEK to the first DEK encryption apparatus through the communication circuit, transmit a second EDEK decryption request message including the second EDEK and the identification information of the second KEK to the second DEK encryption apparatus through the communication circuit, and transmit a third EDEK decryption request message including the third EDEK and the identification information of the third KEK to the third DEK encryption apparatus through the communication circuit. The instructions, when executed by the processor, may cause the electronic apparatus to, based on the first DEK received from the first DEK encryption apparatus and the second DEK received from the second DEK encryption apparatus matching each other and a third DEK received from the third DEK encryption apparatus being inconsistent with the first DEK and the second DEK, transmit a fourth DEK encryption request message including the first DEK or the second DEK to the third DEK encryption apparatus. The instructions, when executed by the processor, may cause the electronic apparatus to receive a fourth DEK encryption response message including a fourth EDEK from the third DEK encryption apparatus, and store the fourth EDEK in the third storage area instead of the third EDEK.

According to an embodiment, a method of operating an electronic apparatus (e.g., the DEK management apparatus 201 of FIG. 2) is provided. The method may include operations of: generating a data encryption key (DEK); and transmitting a first DEK encryption request message including the DEK to a first DEK encryption apparatus, and transmitting a second DEK encryption request message including the DEK to a second DEK encryption apparatus. The method may include operations of: receiving a first DEK encryption response message including a first encrypted DEK (EDEK) generated by encrypting the DEK using a first key encryption key (KEK) and identification information of the first KEK from the first DEK encryption apparatus, and receiving a second DEK encryption response message including a second EDEK generated by encrypting the DEK using a second KEK and identification information of the second KEK from the second DEK encryption apparatus; and storing the first EDEK, the identification information of the DEK, and the identification information of the first KEK in a first storage area corresponding to the first DEK encryption apparatus, and storing the second EDEK, the identification information of the DEK, and the identification information of the second KEK in a second storage area corresponding to the second DEK encryption apparatus.

The method may include operations of: receiving a DEK inquiry request message including the identification information of the DEK from a client device; based on the DEK inquiry request message being received, transmitting a first EDEK decryption request message including the first EDEK and the identification information of the first KEK to the first DEK encryption apparatus, and transmitting a second EDEK decryption request message including the second EDEK and the identification information of the second KEK to the second DEK encryption apparatus; and transmitting a first DEK received from the first DEK encryption apparatus or a second DEK received from the second DEK encryption apparatus to the client device.

The operation of transmitting the first DEK or the second DEK to the client device may include an operation of transmitting one that arrived first among the first DEK and the second DEK to the client device.

The operation of transmitting the first DEK or the second DEK to the client device may include an operation of transmitting the first DEK or the second DEK to the client device based on the first DEK and the second DEK matching each other.

The method may include operations of: receiving a DEK inquiry request message including the identification information of the DEK from a client device; and based on the DEK inquiry request message being received, transmitting a first EDEK decryption request message including the first EDEK and the identification information of the first KEK to the first DEK encryption apparatus, and transmitting a second EDEK decryption request message including the second EDEK and the identification information of the second KEK to the second DEK encryption apparatus. The method may include an operation of transmitting a warning message to the client device based on the first DEK received from the first DEK encryption apparatus and the second DEK received from the second DEK encryption apparatus being inconsistent.

The method may include an operation of, based on a predetermined EDEK examination time having arrived, transmitting a first EDEK decryption request message including the first EDEK and the identification information of the first KEK to the first DEK encryption apparatus, and transmitting a second EDEK decryption request message including the second EDEK and the identification information of the second KEK to the second DEK encryption apparatus. The method may include an operation of, based on the first DEK received from the first DEK encryption apparatus and the second DEK received from the second DEK encryption apparatus not matching, decrypting encrypted data with the first DEK and the second DEK and comparing sample data with first DEK-based decrypted data and second DEK-based decrypted data. The method may include an operation of, based on the first DEK-based decrypted data being the same as the sample data and the second DEK-based decrypted data being inconsistent with the sample data, transmitting a third DEK encryption request message including the first DEK to the second DEK encryption apparatus. The method may include operations of: receiving a third DEK encryption response message including a third EDEK from the second DEK encryption apparatus; and storing the third EDEK in the second storage area instead of the second EDEK.

The method may include operations of: transmitting a third DEK encryption request message including the DEK to a third DEK encryption apparatus; receiving a third DEK encryption response message including a third EDEK generated by encrypting the DEK using a third KEK and identification information of the third KEK from the third DEK encryption apparatus; and storing the third EDEK, the identification information of the DEK, and the identification information of the third KEK in a third storage area of the memory corresponding to the third DEK encryption apparatus. The method may include an operation of, based on a DEK inquiry request message including the identification information of the DEK being received from a client device or a predetermined EDEK examination time having arrived, transmitting a first EDEK decryption request message including the first EDEK and the identification information of the first KEK to the first DEK encryption apparatus, transmitting a second EDEK decryption request message including the second EDEK and the identification information of the second KEK to the second DEK encryption apparatus, and transmitting a third EDEK decryption request message including the third EDEK and the identification information of the third KEK to the third DEK encryption apparatus. The method may include an operation of, based on the first DEK received from the first DEK encryption apparatus and the second DEK received from the second DEK encryption apparatus matching each other and a third DEK received from the third DEK encryption apparatus being inconsistent with the first DEK and the second DEK, transmitting a fourth DEK encryption request message including the first DEK or the second DEK to the third DEK encryption apparatus. The method may include operations of: receiving a fourth DEK encryption response message including a fourth EDEK from the third DEK encryption apparatus; and storing the fourth EDEK in the third storage area instead of the third EDEK.

According to an embodiment, a recording medium storing instructions readable in an electronic apparatus (e.g., the DEK management apparatus 201 of FIG. 2) is provided. The instructions, when executed by at least one processor of the electronic apparatus, may cause the electronic apparatus to perform operations of: generating a data encryption key (DEK); and transmitting a first DEK encryption request message including the DEK to a first DEK encryption apparatus, and transmitting a second DEK encryption request message including the DEK to a second DEK encryption apparatus. The instructions, when executed by the processor of the electronic apparatus, may cause the electronic apparatus to perform an operation of receiving a first DEK encryption response message including a first encrypted DEK (EDEK) generated by encrypting the DEK using a first key encryption key (KEK) and identification information of the first KEK from the first DEK encryption apparatus, and receiving a second DEK encryption response message including a second EDEK generated by encrypting the DEK using a second KEK and identification information of the second KEK from the second DEK encryption apparatus. The instructions, when executed by the processor of the electronic apparatus, may cause the electronic apparatus to perform an operation of: storing the first EDEK, the identification information of the DEK, and the identification information of the first KEK in a first storage area corresponding to the first DEK encryption apparatus, and storing the second EDEK, the identification information of the DEK, and the identification information of the second KEK in a second storage area corresponding to the second DEK encryption apparatus.

In the above description, prefixes such as “first,” “second,” and “third” are only for distinguishing the same names and do not assign special meanings such as importance or order in themselves.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus, comprising:
a communication circuit;
memory, comprising one or more storage media, storing instructions; and
at least one processor communicatively coupled to the communication circuit and the memory,
wherein the instructions, when executed by the at least one processor individually or collectively, cause the electronic apparatus to:
generate a data encryption key (DEK),
transmit a first DEK encryption request message including the DEK to a first DEK encryption apparatus through the communication circuit,
transmit a second DEK encryption request message including the DEK to a second DEK encryption apparatus through the communication circuit,
receive a first DEK encryption response message including a first encrypted DEK (EDEK) generated by encrypting the DEK using a first key encryption key (KEK) and identification information of the first KEK from the first DEK encryption apparatus,
receive a second DEK encryption response message including a second EDEK generated by encrypting the DEK using a second KEK and identification information of the second KEK from the second DEK encryption apparatus,
store the first EDEK, the identification information of the DEK, and the identification information of the first KEK in a first storage area of the memory corresponding to the first DEK encryption apparatus, and
store the second EDEK, the identification information of the DEK, and the identification information of the second KEK in a second storage area of the memory corresponding to the second DEK encryption apparatus.

2. The electronic apparatus of claim 1, wherein the instructions, when executed by the at least one processor individually or collectively, further cause the electronic apparatus to:
receive a DEK inquiry request message including the identification information of the DEK from a client device through the communication circuit;
based on the DEK inquiry request message being received,
transmit a first EDEK decryption request message including the first EDEK and the identification information of the first KEK to the first DEK encryption apparatus through the communication circuit;
transmit a second EDEK decryption request message including the second EDEK and the identification information of the second KEK to the second DEK encryption apparatus through the communication circuit; and
transmit a first DEK received from the first DEK encryption apparatus or a second DEK received from the second DEK encryption apparatus to the client device through the communication circuit.

3. The electronic apparatus of claim 2, wherein the instructions, when executed by the at least one processor individually or collectively, further cause the electronic apparatus to:
transmit one that arrived first among the first DEK and the second DEK to the client device through the communication circuit.

4. The electronic apparatus of claim 2, wherein the instructions, when executed by the at least one processor individually or collectively, further cause the electronic apparatus to:
transmit the first DEK or the second DEK to the client device based on the first DEK and the second DEK matching each other.

5. The electronic apparatus of claim 1, wherein the instructions, when executed by the at least one processor individually or collectively, further cause the electronic apparatus to:
receive a DEK inquiry request message including the identification information of the DEK from a client device through the communication circuit;
based on the DEK inquiry request message being received,
transmit a first EDEK decryption request message including the first EDEK and the identification information of the first KEK to the first DEK encryption apparatus through the communication circuit;
transmit a second EDEK decryption request message including the second EDEK and the identification information of the second KEK to the second DEK encryption apparatus through the communication circuit; and
transmit a warning message to the client device based on a first DEK received from the first DEK encryption apparatus and the second DEK received from a second DEK encryption apparatus being inconsistent.

6. The electronic apparatus of claim 1, wherein the instructions, when executed by the at least one processor individually or collectively, further cause the electronic apparatus to:
based on a predetermined EDEK examination time having arrived,
transmit a first EDEK decryption request message including the first EDEK and the identification information of the first KEK to the first DEK encryption apparatus through the communication circuit;
transmit a second EDEK decryption request message including the second EDEK and the identification information of the second KEK to the second DEK encryption apparatus through the communication circuit;
based on the first DEK received from the first DEK encryption apparatus and the second DEK received from the second DEK encryption apparatus not matching,
decrypt encrypted data stored in the memory with the first DEK and the second DEK;
compare sample data stored in the memory with first DEK-based decrypted data and second DEK-based decrypted data;
based on the first DEK-based decrypted data being the same as the sample data and the second DEK-based decrypted data being inconsistent with the sample data,
transmit a third DEK encryption request message including the first DEK to the second DEK encryption apparatus;
receive a third DEK encryption response message including a third EDEK from the second DEK encryption apparatus; and
store the third EDEK in the second storage area instead of the second EDEK.

7. The electronic apparatus of claim 1, wherein the instructions, when executed by the at least one processor individually or collectively, further cause the electronic apparatus to:
transmit a third DEK encryption request message including the DEK to a third DEK encryption apparatus through the communication circuit;
receive a third DEK encryption response message including a third EDEK generated by encrypting the DEK using a third KEK and identification information of the third KEK from the third DEK encryption apparatus;
store the third EDEK, the identification information of the DEK, and the identification information of the third KEK in a third storage area of the memory corresponding to the third DEK encryption apparatus; and
based on a DEK inquiry request message including the identification information of the DEK being received from a client device through the communication circuit or a predetermined EDEK examination time having arrived,
transmit a first EDEK decryption request message including the first EDEK and the identification information of the first KEK to the first DEK encryption apparatus through the communication circuit;
transmit a second EDEK decryption request message including the second EDEK and the identification information of the second KEK to the second DEK encryption apparatus through the communication circuit;
transmit a third EDEK decryption request message including the third EDEK and the identification information of the third KEK to the third DEK encryption apparatus through the communication circuit;
based on the first DEK received from the first DEK encryption apparatus and the second DEK received from the second DEK encryption apparatus matching each other and a third DEK received from the third DEK encryption apparatus being inconsistent with the first DEK and the second DEK,
transmit a fourth DEK encryption request message including the first DEK or the second DEK to the third DEK encryption apparatus;
receive a fourth DEK encryption response message including a fourth EDEK from the third DEK encryption apparatus; and
store the fourth EDEK in the third storage area instead of the third EDEK.

8. A method performed by an electronic apparatus, the method comprising:
generating a data encryption key (DEK);
transmitting a first DEK encryption request message including the DEK to a first DEK encryption apparatus, and transmitting a second DEK encryption request message including the DEK to a second DEK encryption apparatus;
receiving a first DEK encryption response message including a first encrypted DEK (EDEK) generated by encrypting the DEK using a first key encryption key (KEK) and identification information of the first KEK from the first DEK encryption apparatus;
receiving a second DEK encryption response message including a second EDEK generated by encrypting the DEK using a second KEK and identification information of the second KEK from the second DEK encryption apparatus;
storing the first EDEK, the identification information of the DEK, and the identification information of the first KEK in a first storage area corresponding to the first DEK encryption apparatus; and
storing the second EDEK, the identification information of the DEK, and the identification information of the second KEK in a second storage area corresponding to the second DEK encryption apparatus.

9. The method of claim 8, further comprising:
receiving a DEK inquiry request message including the identification information of the DEK from a client device;
based on the DEK inquiry request message being received,
transmitting a first EDEK decryption request message including the first EDEK and the identification information of the first KEK to the first DEK encryption apparatus;
transmitting a second EDEK decryption request message including the second EDEK and the identification information of the second KEK to the second DEK encryption apparatus; and
transmitting a first DEK received from the first DEK encryption apparatus or a second DEK received from the second DEK encryption apparatus to the client device.

10. The method of claim 9, wherein the transmitting of the first DEK or the second DEK to the client device comprises:
transmitting one that arrived first among the first DEK and the second DEK to the client device.

11. The method of claim 9, wherein the transmitting of the first DEK or the second DEK to the client device comprises:
transmitting the first DEK or the second DEK to the client device based on the first DEK and the second DEK matching each other.

12. The method of claim 8, further comprising:
receiving a DEK inquiry request message including the identification information of the DEK from a client device;
based on the DEK inquiry request message being received,
transmitting a first EDEK decryption request message including the first EDEK and the identification information of the first KEK to the first DEK encryption apparatus;
transmitting a second EDEK decryption request message including the second EDEK and the identification information of the second KEK to the second DEK encryption apparatus; and
transmitting a warning message to the client device based on the first DEK received from the first DEK encryption apparatus and the second DEK received from the second DEK encryption apparatus being inconsistent.

13. The method of claim 8, further comprising:
based on a predetermined EDEK examination time having arrived,
transmitting a first EDEK decryption request message including the first EDEK and the identification information of the first KEK to the first DEK encryption apparatus;
transmitting a second EDEK decryption request message including the second EDEK and the identification information of the second KEK to the second DEK encryption apparatus;
based on the first DEK received from the first DEK encryption apparatus and the second DEK received from the second DEK encryption apparatus not matching,
decrypting encrypted data with the first DEK and the second DEK and comparing sample data with first DEK-based decrypted data and second DEK-based decrypted data;
based on the first DEK-based decrypted data being the same as the sample data and the second DEK-based decrypted data being inconsistent with the sample data,
transmitting a third DEK encryption request message including the first DEK to the second DEK encryption apparatus;
receiving a third DEK encryption response message including a third EDEK from the second DEK encryption apparatus; and
storing the third EDEK in the second storage area instead of the second EDEK.

14. The method of claim 8, further comprising:
transmitting a third DEK encryption request message including the DEK to a third DEK encryption apparatus;
receiving a third DEK encryption response message including a third EDEK generated by encrypting the DEK using a third KEK and identification information of the third KEK from the third DEK encryption apparatus;
storing the third EDEK, the identification information of the DEK, and the identification information of the third KEK in a third storage area of memory corresponding to the third DEK encryption apparatus;
based on a DEK inquiry request message including the identification information of the DEK being received from a client device or a predetermined EDEK examination time having arrived, transmitting a first EDEK decryption request message including the first EDEK and the identification information of the first KEK to the first DEK encryption apparatus;
transmitting a second EDEK decryption request message including the second EDEK and the identification information of the second KEK to the second DEK encryption apparatus;
transmitting a third EDEK decryption request message including the third EDEK and the identification information of the third KEK to the third DEK encryption apparatus;
based on the first DEK received from the first DEK encryption apparatus and the second DEK received from the second DEK encryption apparatus matching each other and a third DEK received from the third DEK encryption apparatus being inconsistent with the first DEK and the second DEK,
transmitting a fourth DEK encryption request message including the first DEK or the second DEK to the third DEK encryption apparatus;
receiving a fourth DEK encryption response message including a fourth EDEK from the third DEK encryption apparatus; and
storing the fourth EDEK in the third storage area instead of the third EDEK.

15. One or more non-transitory computer-readable storage media storing one or more computer programs including computer-executable instructions that, when executed by one or more processors of an electronic apparatus, cause the electronic apparatus to perform operations, the operations comprising:
generating a data encryption key (DEK);
transmitting a first DEK encryption request message including the DEK to a first DEK encryption apparatus, and transmitting a second DEK encryption request message including the DEK to a second DEK encryption apparatus;
receiving a first DEK encryption response message including a first encrypted DEK (EDEK) generated by encrypting the DEK using a first KEK and identification information of a first key encryption key (KEK) from the first DEK encryption apparatus;
receiving a second DEK encryption response message including a second EDEK generated by encrypting the DEK using a second KEK and identification information of the second KEK from the second DEK encryption apparatus;
storing the first EDEK, the identification information of the DEK, and the identification information of the first KEK in a first storage area corresponding to the first DEK encryption apparatus; and
storing the second EDEK, the identification information of the DEK, and the identification information of the second KEK in a second storage area corresponding to the second DEK encryption apparatus.

16. The one or more non-transitory computer-readable storage media of claim 15, the operations further comprising:
receiving a DEK inquiry request message including the identification information of the DEK from a client device;
based on the DEK inquiry request message being received,
transmitting a first EDEK decryption request message including the first EDEK and the identification information of the first KEK to the first DEK encryption apparatus;
transmitting a second EDEK decryption request message including the second EDEK and the identification information of the second KEK to the second DEK encryption apparatus; and
transmitting a first DEK received from the first DEK encryption apparatus or a second DEK received from the second DEK encryption apparatus to the client device.
